(19) United States
(12) Patent Application Publication
(10) Pub. No.: US 2024/0383578 A1
(43) Pub. Date: Nov. 21, 2024

(54) SYSTEMS AND METHODS FOR VERTICAL SUPPORTING OF HIGH PRESSURE GAS CYLINDERS

(71) Applicant: Agility Fuel Systems LLC, Costa Mesa, CA (US)

(72) Inventors: John Alan Eihusen, Lincoln, NE (US); Seth A. Wortman, Lincoln, NE (US); Mark A. Babcock, Cumberland, ME (US)

(21) Appl. No.: 18/788,548

(22) Filed: Jul. 30, 2024

Related U.S. Application Data
(63) Continuation of application No. PCT/US2023/011556, filed on Jan. 25, 2023.
(60) Provisional application No. 63/305,568, filed on Feb. 1, 2022.

(51) Int. Cl. B63B 25/00

(52) U.S. Cl. CPC B63B 25/004

(57) ABSTRACT

A pressure receptacle support system is provided that has a pressure receptacle, a first end support assembly, and a rotation interface. The first end support assembly is fastened to a first end of the pressure receptacle. The first end support assembly comprises a ground support and a coupler. The coupler has a receptacle interface at a first end and a rotation interface at or extending from a second end opposite the first end. The receptacle interface is fastened to the first end of the pressure receptacle. The pressure receptacle has a sway range which is provided by rotation of the rotation interface of the coupler relative to the ground support and relative motion of a second end of the pressure receptacle relative to a portion of a deck of a maritime vessel.

### BACKGROUND OF THE INVENTION

### Field of the Invention

The present disclosure relates to the field of storing and/or transporting high pressure gas in cylinders, e.g., compressed natural gas, hydrogen gas, or other gas in cylinders, tubes and other pressure receptacle. More particularly, this application discloses systems and methods for storing and transporting compressed natural gas, hydrogen and other gases in modes including, but limited to Marine transportation, maritime storage, ground storage, and other modes where independent movement of the cylinders is beneficial.

### Description of the Related Art

Compressed natural gas and hydrogen gas are used as fuels in transportation, energy generation, and many other applications. Hydrogen can be used in fuel cells to generate electricity without generating combustion generated pollutants, as occurs when burning gasoline and diesel. Compressed natural gas can be used in internal combustion engines in place of diesel or gasoline and in household applications such as a stove burner. Compressed natural gas can have many advantages over traditional fuel types, offering an alternative fuel source.

These and other useful industrial gases are unevenly distributed around the world. Some regions have easy access to such gasses while others benefit from importing. Furthermore, demand for flammable gasses, compressed natural gas, and other industrial gasses may be greater or lesser in different regions. Thus, it is useful to transport natural gas from region to region. Shipping can be used to move these and other industrial gasses from a source location to a use location.

### SUMMARY OF THE INVENTION

One way to convey gas (e.g., compressed gas, natural gas, compressed natural gas, hydrogen, helium) by maritime vessel (e.g., ship, barge or other maritime application), is to store the gas in cylinders in a cargo hold. High volume cylinders are heavy and managing loading of these cylinders in a structure such as a ship or barge is complex because ship structures sway, rack and deflect due to the weight of the lading and movement through waves and in and out of docks at ports. Furthermore, the repeated motion while being transported transfers forces due to these conditions to the ship structure. Repeated cycling and loading can lead to fatigue in materials used to construct ships. Repeated cycling and loading can also have adverse effects on the integrity of the pressure receptacles. There exists a need for a system configured to improve the process of transporting gas in cylinders on a ship.

The present application discloses systems that are configured to address the need for a system to transport gas (e.g., compressed gas, natural gas, compressed natural gas, hydrogen, helium) on a ship. The disclosed systems help to manage loading of gas storage cylinders on a ship's structure during transportation, increasing the safety and lifespan of the cylinders, support systems and the ship. Further the systems improve loading efficiency of a ship to which they are coupled, by improving weight distribution, providing a smooth process of loading pressurized cylinders on and unloading such cylinders from a ship, simplifying filling and emptying of cylinders, and enhancing storage capacity for the gas.

A system is provided for supporting pressure receptacles (e.g., fuel tanks and other tanks and pressure vessels) on a ship where the receptacle have a sway range. The system comprises a pressure receptacle, a first end support assembly, and a second end support assembly. The pressure receptacle comprises a central portion disposed along a longitudinal axis (LA) of the pressure receptacle, a first neck portion comprising a first boss at a first end, and a second neck portion comprising a second boss at a second end. The second end is opposite the first end. The first neck portion and the second neck portion are disposed along the longitudinal axis (LA) of the receptacle. The first end support assembly is coupled with the first neck portion. The first end support assembly comprises a ground support and a coupler. The coupler can comprise a ground support coupler. The ground support comprises a ball end, an elongate body, and a free end opposite the ball end. The elongate body extends away from the first neck portion towards the free end. The ground support coupler can be disposed between the central cylindrical portion of the pressure receptacle and the free end of the ground support. The free end is positionable in a recess coupled with a bottom portion of a ship. The coupler has a receptacle boss interface at a first end and a spherical opening at a second end opposite the first end. The receptacle boss interface is coupled with the first boss. The second end support assembly is coupled with the second neck portion. The second end support assembly comprises a ship deck coupler, a spherical member, a concave bearing, and a rotation control member. The ship deck coupler is configured to be secured to a portion of an upper deck of a ship. The spherical member is coupled with an outer surface of the second boss and the concave bearing is disposed between the spherical member and the ship deck coupler. The spherical member can comprise a projection of the outer surface of the second boss, e.g., coupled with, a unitary or monolithic portion of the second boss. The rotation control member is secured to the second boss of the pressure receptacle and is configured to prevent rotation (e.g., about the longitudinal axis LA) of the pressure receptacle relative to a ship deck. The sway range is provided by pivoting of the spherical opening of the coupler over the ball end of the ground support. The sway range is further provided by translation of the outer surface of the second boss through the spherical member, such that a load applied by the pressure receptacle to the ship is maintained substantially vertical.

A pressure receptacle support system is provided that has a pressure receptacle, a first end support assembly, and a rotation interface. The pressure receptacle comprises a central portion disposed along a longitudinal axis of the pressure receptacle, a first end, and a second end opposite the first end. The first and second ends are disposed along the longitudinal axis. The first end support assembly is fastened to the first end. The first end support assembly comprises a ground support and a coupler. The coupler can comprise or may be described as a ground support coupler. The coupler has a receptacle interface at a first end and a rotation interface at or extending from a second end opposite the first end. The receptacle interface is fastened to the first end of the pressure receptacle. The pressure receptacle has a sway range which is provided by rotation of the rotation interface of the coupler relative to the ground support and relative motion of the second end of the pressure receptacle relative to a portion of a deck of a ship.

A pressure receptacle support system providing sway control for a pressure receptacle is provided. The pressure receptacle support system comprises a first end support assembly and a second end support assembly. The first end support assembly is configured to couple with a first neck portion of a vertically oriented pressure receptacle. The first end support assembly comprises a ground support and a coupler. The coupler can comprise a ground support coupler. The ground support comprises a first pivot structure, an elongate body, and a free end opposite the first pivot structure. The elongate body is configured to extend away from the first neck portion to the free end. The coupler has a receptacle boss interface that is configured to couple with a first boss at a first end and a second pivot structure at or extending from a second end opposite the first end. The second end support assembly is configured to couple with a second neck portion of a vertically oriented pressure receptacle. The second end support assembly comprises an upper coupler and a spherical member. The upper coupler is configured to be secured to an upper support structure and the spherical member is configured to be coupled with an outer surface of a second boss of a pressure receptacle. The spherical member is mounted within and pivotable relative to the ship deck coupler. The fuel support system has a range of angulation which is provided by rotation of the spherical opening of the coupler over the ball end of the ground support and by sliding of the spherical member along the second boss.

A pressure receptacle having a central portion, a first neck portion, a and second neck portion is provided. The central portion disposed along a longitudinal axis (LA). The first neck portion comprises ac first boss at a first end of the central portion and the first boss comprises a first array of fastener apertures. The second neck portion comprises a second boss at a second end of the central portion opposite the first end. The second boss comprises one or more, e.g., a second array of, fastener apertures. The pressure receptacle has a plug configured to seal one end of a volume disposed within the central portion. The second boss comprises a first length that is configured to be supported by a ship deck coupler over a first range of positions between an empty condition and a full condition and a second length that is configured to be supported by a ship deck coupler over a second range of positions between a full tilted orientation and a full vertical orientation. The full tilted orientation resulting from swaying of the pressure receptacle away from the full vertical orientation relative to a support structure with which the pressure receptacle is coupled.

### BRIEF DESCRIPTION OF THE DRAWINGS

Features of the invention can be better understood from the following detailed description when read in conjunction with the accompanying schematic drawings, which are for illustrative purposes only. The drawings include the following figures:

FIG. 1 is a side cross-sectional view of a ship, showing several compartments including a fuel storage compartment;

FIG. 1A is a schematic view of fuel tanks illustrating movement or swaying of the tanks during a voyage;

FIGS. 1B and 1C show the orientation of the fuel tanks at two orientations of a ship relative to vertical;

FIG. 2 is a top perspective view of an array of fuel tanks supported at opposing ends by lower (or first) end support assemblies and upper (or second) end support assemblies;

FIG. 3A is a detail view of lower end support assemblies of the fuel tank support system shown in FIG. 2;

FIG. 3B is a detail view of the upper end support assemblies of the fuel tank support system shown in FIG. 2;

FIG. 4 is a bottom perspective view of a first (lower) end of a fuel tank and a lower support assembly;

FIG. 4A is a cross-sectional view of the lower support assembly and a portion of the first end of the tank, the section plane including the longitudinal axis of the fuel tank;

FIG. 4B is a cross-sectional view of another configuration in which a concave ground support engages a convex surface of a projection of a boss/ground coupler;

FIG. 5 is a top perspective view of a ground support coupler for connecting a lower end of a fuel tank to a ship hull;

FIG. 6 is a bottom perspective view of the lower end of one of the tanks seen in FIG. 2;

FIG. 7 is a side view of upper ends of a plurality of tanks each coupled with a ship deck by a second (upper) end support assembly;

FIG. 7A is a cross-sectional view of the upper end of one of the tanks in FIG. 7, showing details of the second end support assembly, the section plane including the longitudinal axis of the fuel tank;

FIGS. 8-8D illustrate a manner or method of coupling the fuel tanks to a portion of a hull of a ship; and

FIG. 9 is a schematic representation of a spherical pressure receptacle.

### DETAILED DESCRIPTION OF THE PREFERRED EMBODIMENT

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein. Each and every feature described herein, and each and every combination of two or more of such features, is included within the scope of the present invention provided that the features included in such a combination are not mutually inconsistent.

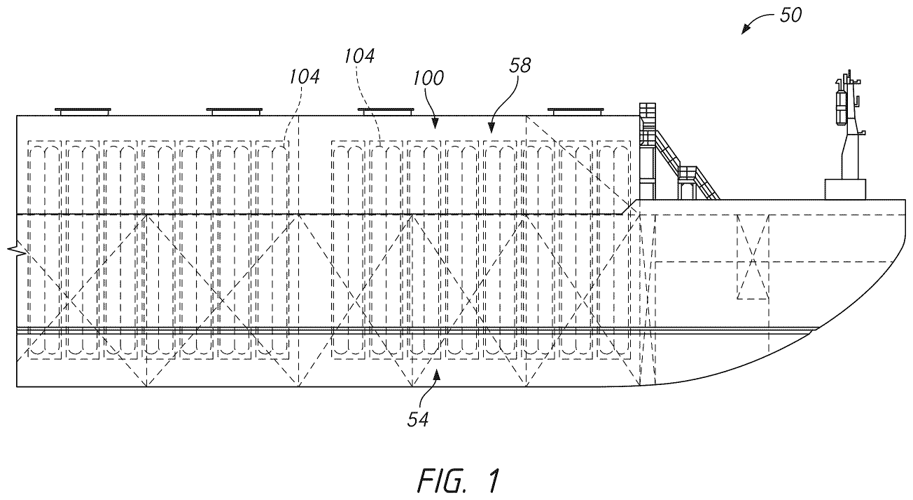

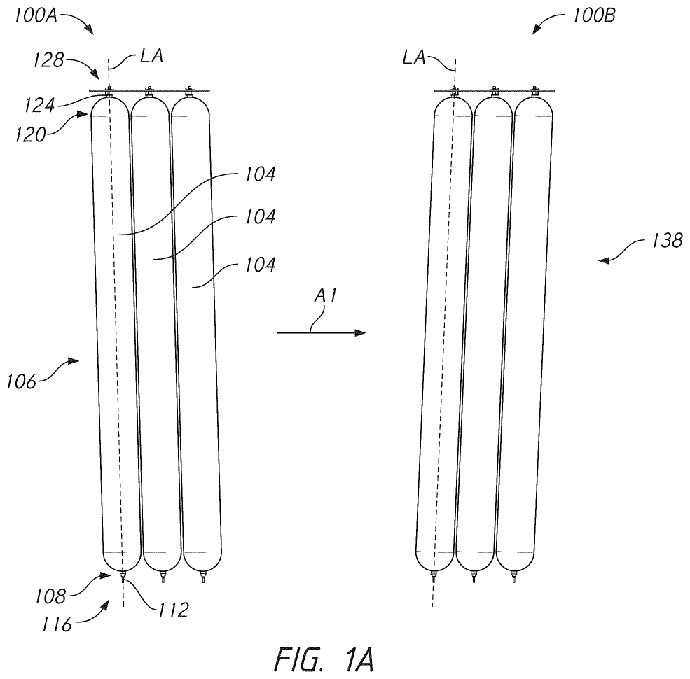

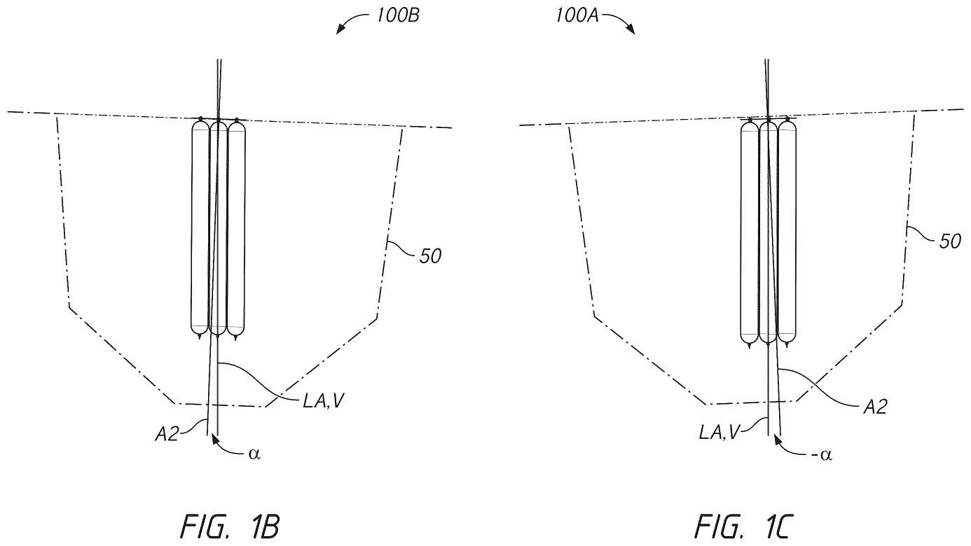

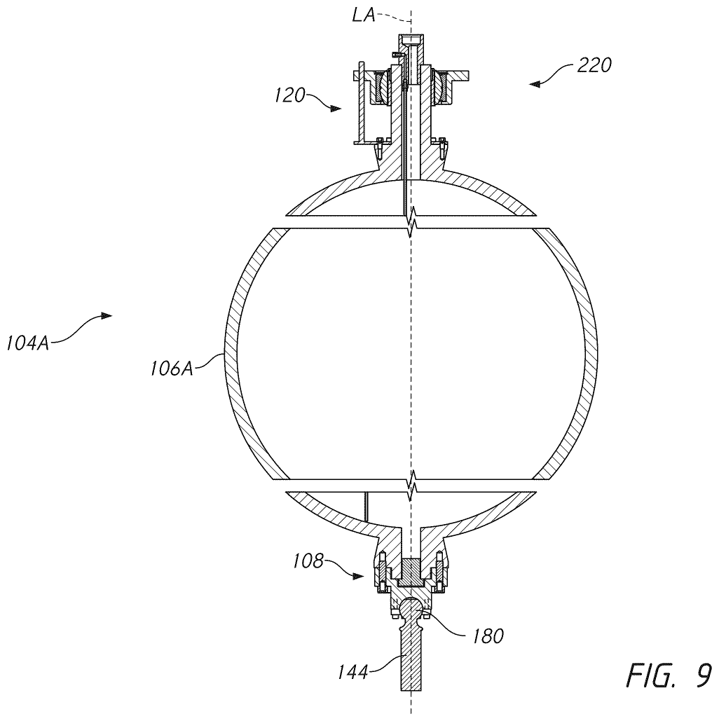

This disclosure relates to an embodiment of a system for supporting fuel tanks on a ship 50 as illustrated in FIG. 1. A fuel tank support system 100 can be mounted within the ship 50. The ship 50 is an example of a maritime vessel that can be fitted with the fuel tank support system 100. Other maritime vessels, such as barges and other marine vessels, can also be equipped with the fuel tank support system 100. The fuel tank support system 100 can be configured for storing fuel during shipment from a port at a source location to a port at a use location. The fuel tanks 104 are located within an enclosed space within the ship, e.g., within a cargo hold. The tanks 104 can extend from a bottom portion 54 of the marine vessel 50 to a deck 58, e.g., the upper deck, or in some cases even higher than an upper deck. In the present embodiments the fuel tanks 104 are mounted substantially vertically in the ship 50. The fuel tanks 104 extend from the bottom portion 54, e.g., from an internal structure coupled with or supporting the keel and/or hull. The ship 50 can be configured to support the fuel tanks 104 throughout the cargo hold. The fuel tanks 104 can extend from the front (bow) to the back (stern) of the ship 50 and from the port side to the starboard side of the ship. The tanks 104 can all be the same size or the tanks 104 can be of different sizes. Different sized tanks 104 can allow for better optimization of the use of the space of the cargo hold. In one embodiment the fuel tanks 104 can be taller in the center of the ship and shorter (or smaller) as they are placed further towards the bow, stern, port side, or starboard side. The fuel tanks 104 can also vary in diameter and shape in order to optimize or otherwise improve the use of the space available on the ship, manufacturing, loading, unloading of the tanks, or for any other reason. Some or all of the tanks 104 can have a cylindrical shape. Some or all of the tanks 104 can have a spherical shape or other shape that is not cylindrical. FIG. 9 illustrates a pressure receptacle 104A that is similar to the fuel tank 104, including the first neck portion 108 and the second neck portion 120. The pressure receptacle 104A includes a central portion 106A that has a spherical wall configuration. A first gap is shown between the top of the central portion 106A and the second neck portion 120 and a second gap is shown between the bottom of the central portion 106A and first neck portion 108. The gaps would be closed by connecting the spherical wall portion to the second neck portion 120 and the first neck portion 108 in a suitable manner, such as by welding and wrapping a reinforcement layer over the construct to withstand the pressure to be contained.

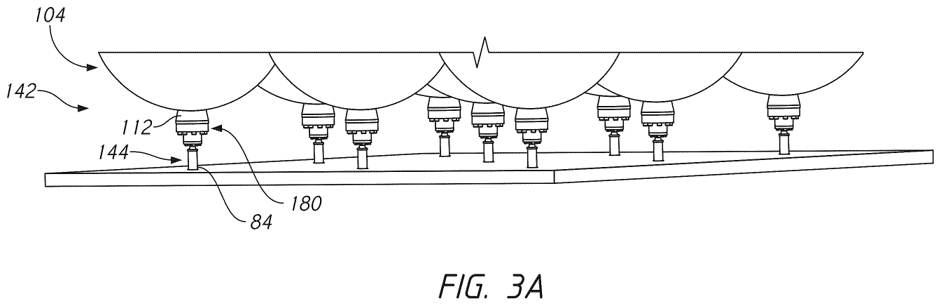

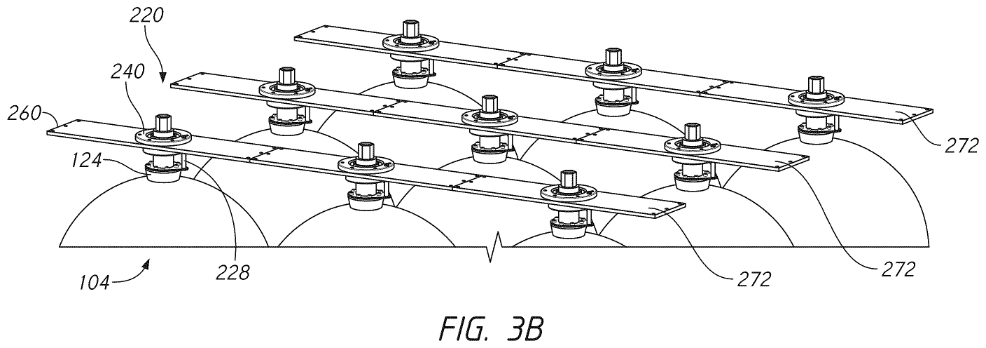

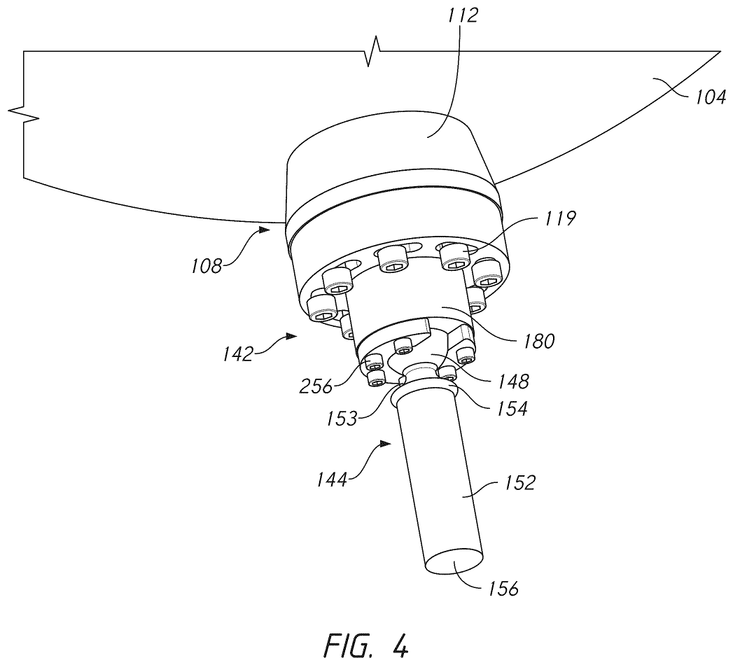

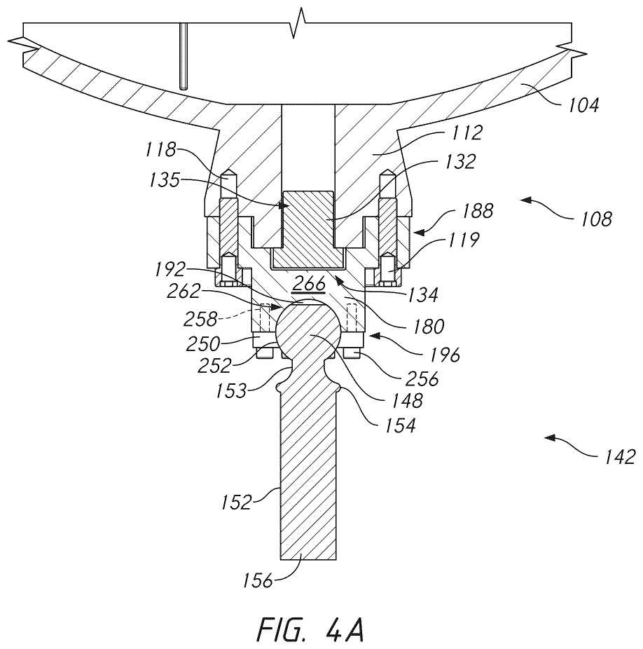

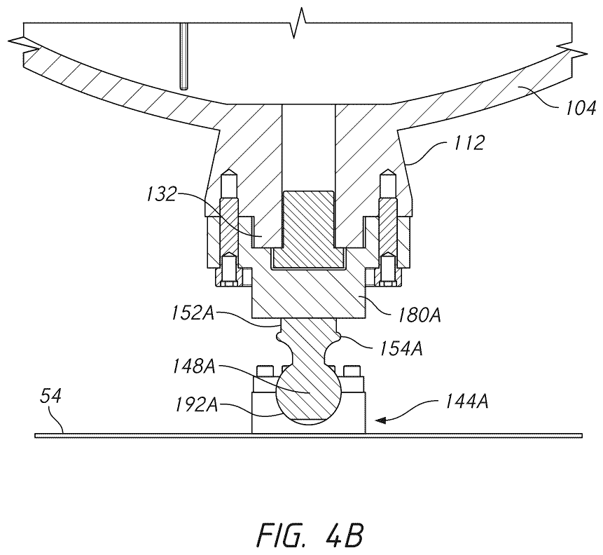

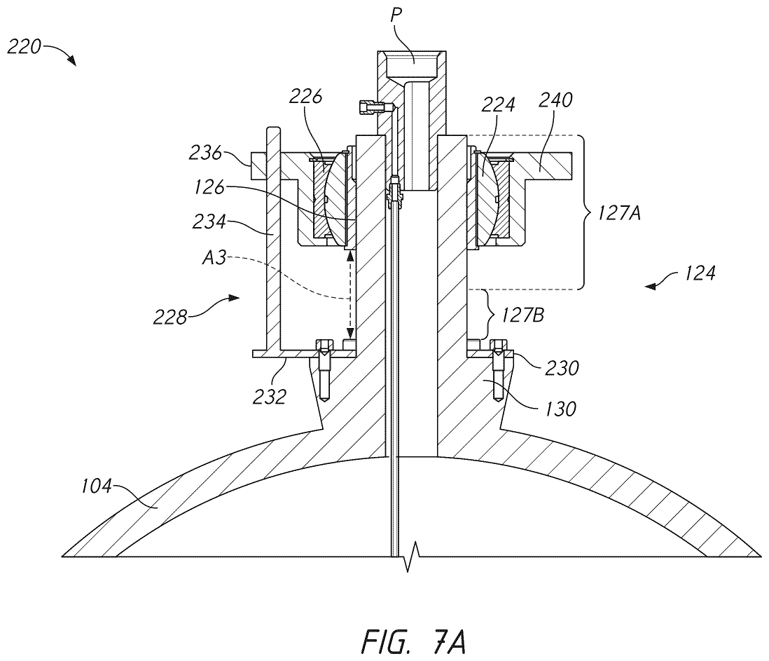

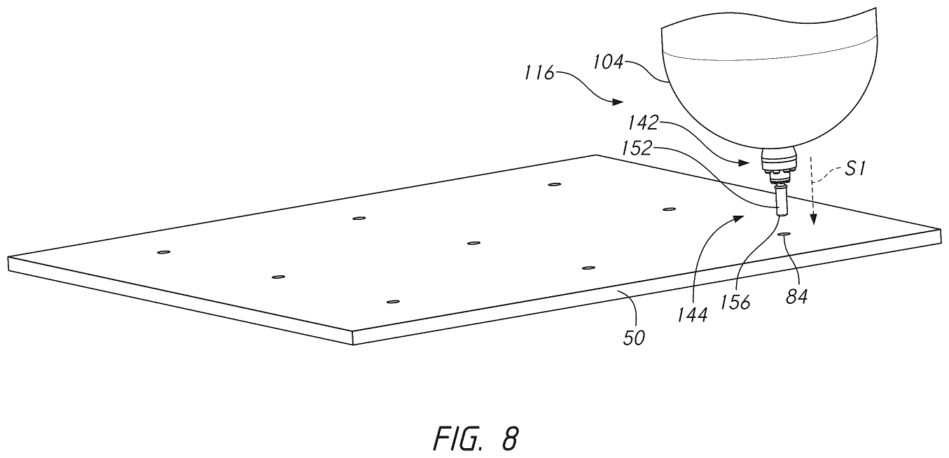

FIGS. 1A-1C show a sway range (100A-100B) of the fuel tank support system 100. FIG. 1A shows three fuel tanks 104 of an array of tanks in the fuel tank support system 100. The fuel tank 104 have a cylindrical portion 106, a first end 116, a second end 128 and a longitudinal axis LA extending through the cylindrical portion 106 and the ends 116, 128. A first neck portion 108 is located at the first end 116 and comprises a first boss 112. A second neck portion 120 is located at the second end 128 and comprises a second boss 124. The fuel tank support system 100 includes a first end support assembly 142 (see, e.g., FIGS. 3, 4 and 4A) and a second end support assembly 220 (see FIGS. 3B, 7 and 7A) that facilitate swaying of the fuel tanks 104. These support assemblies enable the fuel tanks 104 to remain vertical or close to vertical as the ship 50 sways from side to side. The sway range is illustrated in FIG. 1A by the arrow A1 showing that the same three fuel tanks 104 can have the longitudinal axis LA thereof inclined relative to an axis in a first direction (100A) and inclined relative to an axis in a second direction (100B) opposite the first direction.

FIGS. 1B and 1C show the effect illustrated schematically relative to the leaning of the ship 50. In FIG. 1B, the ship 50 is leaning toward the starboard side. The deck of the ship 50 is inclined from starboard to the port side. A normal axis A2 to the plane of the deck of the ship is inclined by an angle α from vertical. The fuel tanks 104 are mounted by the support assemblies 142, 220 that enable the tanks 104 to remain vertical, e.g., the longitudinal axis LA of the fuel tanks 104 can remain aligned with the vertical direction V. As a result the longitudinal axis LA is disposed at an angle α from the normal axis A2 to the plane of the deck of the ship 50. In FIG. 1C the ship 50 is leaning toward the port side. The deck of the ship 50 is inclined from port to starboard side. The normal axis A2 to the plane of the deck of the ship is inclined by an angle α from vertical. The support assemblies 142, 220 of the fuel tank support system 100 enable the fuel tanks 104 to be oriented such that the longitudinal axis LA is aligned with the vertical direction V. As a result the longitudinal axis LA is disposed at an angle −α a from the normal axis A2 to the plane of the deck of the ship 50. The sway range illustrated by FIGS. 1A-1C maintains the weight of the fuel tanks 104 vertical to improve the loading on the ship 50 and to reduce wear and fatigue on the fuel tank support system 100 and the on the ship 50.

The swaying as shown is FIGS. 1A-1C is 2 dimensional but can be a 3-dimensional sway in any direction as the ship 50 is oriented relative to horizontal and/or flexes in response to loads due to waves. In the present embodiment the fuel tanks 104 sway about a pivot point disposed at or connected to the first end 116. As the tanks 104 sway the second end support assembly 220 can pivot, provide a vertical adjustment/compliance, and/or pivot and provide vertical adjustment/compliance. The vertical adjustment/compliance of the upper end support assembly allows the fuel tanks 104 to more easily sway, reducing stress on the ship deck, the ship, and the fuel tanks 104. In another embodiment, vertical adjustment could be provided at or adjacent to the first end 116 and pivoting about a point can be provided at the upper end.

While this application discusses the use of the fuel tank support system 100 within a maritime vessel, other uses and applications are also within the scope of this disclosure. For example, although much of the disclosure describes the support of fuel tanks, the systems apply more generally to supporting any pressure receptacle, including receptacles configured for storing pressurized gasses which may have a use other than as a combustions fuel or in generating electricity through a fuel cell, for example. Also, although this disclosure describes systems for supporting cylinders, this disclosure broadly covers systems that support spherical and other shaped pressure receptacles. While providing a sway range is beneficial in maritime vessels, ground storage is also within the scope of this disclosure. For example, maritime storage and other forms of ground storage can also employ the systems disclosed herein when independent movement of receptacles within an array of receptacles is beneficial.

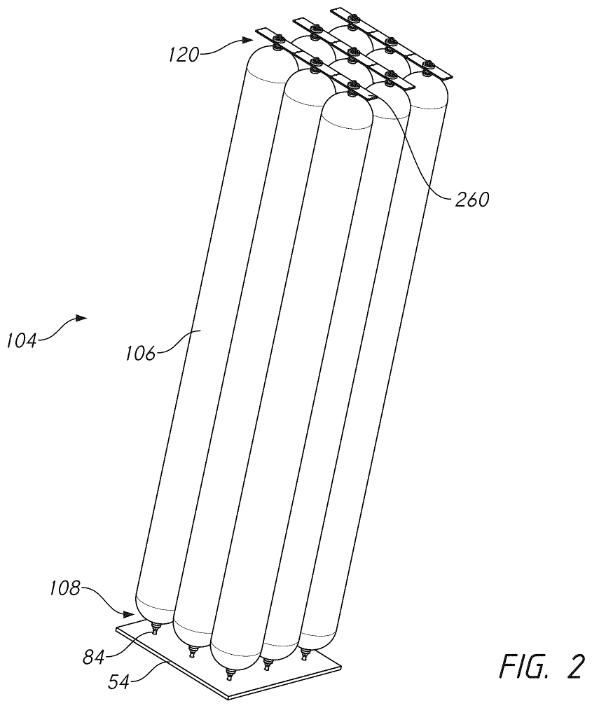

FIGS. 2-3B show further details to the engagement of the fuel tank support system 100 with the ship 50. The surrounding structure of the ship 50 other than a portion of a keel or ground surface coupled with a keel and a portion of a deck thereof is omitted in FIGS. 2-3B for clarity. The first end support assembly 142 (see FIG. 3A) is connected to the first end 116 of each of the fuel tanks 104, e.g., at the first boss 112 of each tank. The first end support assembly 142 supports the weight of the tank 104. The first end support assembly 142 allows the tank 104 to pivot about a point or structure disposed at or adjacent to the first end 116 of the tank 104. The first end support assembly 142 keeps the tank in a substantially vertical orientation while allowing it to sway, thus managing loading on the fuel tanks 104 and the ship 50. The first end support assembly 142 and the second end support assembly 220 work in conjunction or independently to allow the fuel tank 104 with which they are coupled to sway and at least one end portion to translate, thus reducing forces on the fuel tank 104 and the ship 50. These forces can be encountered due to the bending, twisting, or other deformation of the ship 50, in addition to leaning from side to side and pitching over waves, during travel. Further the system 100 acts to reduce forces on the tanks during contraction and expansion due to filling, emptying, temperature change, or a pressure change.

The fuel tank support system 100 can be provided on one or all of an array of fuel tanks 104 supported by one or more of the hull, keel, cargo hold, walls, or an intermediate member of the ship 50. As discussed above, the fuel tank 104 comprises a cylindrical portion 106 disposed along a longitudinal axis LA of the fuel tank 104, the first end 116, and the second end 128. The fuel tank 104 can further comprise the second neck portion 120 comprising the second boss 124 at the second end 128 opposite of the first end 116.

FIG. 3A shows the first end support assembly 142 coupled with the first neck portion 108, e.g., with the first boss 112 at the first end 116. The first end support assembly 142 can comprise a ground support 144 and a coupler 180. In the present embodiment the ground support 144 is configured to be inserted into the keel/hull/ground surface of the ship 50 to fix a position of the ground support 144. If an array of fuel tanks 104 is provided, the ground supports 144 can all be on the same plane or can be in different planes (e.g., supported at different elevations within a cargo hold). The ground support 144 can connect to a plate or an intermediate component, or it can connect directly to the hull, ground surface, or keel of the ship 50. The coupler 180 is configured to be pivotable relative to the ground support 144. In one use, the coupler 180 is coupled to the tank 104 and the ground support 144 is coupled with the ship 50. The coupler 180 and the ground support 144 are configured to provide for relative rotation therebetween, as discussed further below.

FIG. 3B shows that the second end support assembly 220 can be coupled with the second end 128 of the fuel tank 104 and, in some embodiments, can be coupled with the second boss 124 or another part of the second neck portion 120. The second end support assembly 220 can be configured to allow some relative movement between the fuel tank 104 and a deck portion, such as a rail 260 or other structural member. In one embodiment, relative motion includes longitudinal extension of the second boss 124 toward or through the rail 260 or other portion of a ship deck, or toward or through a ship deck coupler. In one embodiment, relative motion can include rotation about a transverse axis of the fuel tank 104 relative to the rail 260 or portion of the ship deck.

FIGS. 2-3B also demonstrate that the fuel tank (or other pressure receptacle) support system 100 can be used in a ground support application. In that case, the recess 84 can be formed in a bottom portion 54 of a ground support installation. The bottom portion 54 can be a fixed foundation of a ground installation that can be disposed on land or on an underwater ground surface. The recesses 84 can be formed in the bottom portion 54. An upper portion of the system 100, e.g., the second neck portion 120, can be supported by a rail 260 or elongate body (in place of the ship deck 272), which can be part of a support structure that has some degrees of freedom of movement from the bottom portion 54. In one example, the bottom portion 54 is an underwater array of connection points or recesses 84. The rail 260 can be part of a floating or over-water support to keep one or an array of pressure receptacles (e.g., fuel tank 104) substantially vertical in the water.

FIG. 7A shows that the second end support assembly 220 can include a ship deck coupler 240, a spherical member 224, and a concave bearing 226. The second end support assembly 220 can include a rotation control member 228 configured to limit or prevent rotation of the fuel tank 104 about the longitudinal axis LA of the fuel tank. As discussed above, the ship deck coupler 240 (sometimes referred to herein as a sway guide) or other portion of the second end support assembly 220 can be connected to the rail 260 or another portion of the ship deck. The spherical member 224 or another portion of the second end support assembly 220 can further be connected to the second end 128 of the tank 104. The spherical member 224 can be connected to the second neck portion 120, e.g., to an outer surface 126 of the second boss 124. The spherical member 224 can be slideably disposed over the outer surface 126 of the second boss 124. The spherical member 224 may be moveable over the outer surface 126 of the second boss 124 up to an entire length of the neck, e.g., of the boss 126, due to expansion during filling and/or due to swaying. In some embodiments, the spherical member 224 is moveable over the outer surface of the boss 126 up to 10 mm due to expansion during filling and/or due to swaying. In other embodiments, up to 5 mm, 15 mm, 20 mm, 25 mm, 30 mm, 35 mm, 40 mm, 50 mm, 75 mm, or 100 mm or within a range defined by any two of the foregoing values as end points. In one application, the spherical member 224 is configured as a ball mount journal bearing. An inner surface of the spherical member 224 can slide along the outer surface 126 as the conditions of the fuel tank 104 change. One changed condition can include increased or decreased pressure (generally changed pressure state) of the fuel tank 104. When the fuel tank 104 is filled and pressurized, the length of the tank (e.g., from the first boss 112 to the second boss 124) can increase. As the length increases, the outer surface 126 of the second boss 124 can slide within and through the ship deck coupler 240 to protrude to a greater extent out of the spherical member 224. When the fuel tank 104 is empty, the second boss 124 can retract downward relative to or within the spherical member 224, e.g., the outer surface 126 can slide downward through the spherical member 224. Also, as the fuel tank 104 tilts within the ship 50 a larger angle α can cause the second boss 124 to be retracted within the spherical member 224. Thus, a tilted state of the fuel tank 104 can be another changed condition altering the position of the second boss 124 relative to the spherical member 224.

The spherical member 224 can also rotate within the concave bearing 226. The rotation of the spherical member 224 within the concave bearing 226 can alter the angle of the longitudinal axis LA of the fuel tank 104 to the ship deck or can alter the angle α. The rotation of the spherical member 224 within the concave bearing 226 can facilitate swaying of the fuel tank 104, e.g., within or relative to the ship 50.

FIGS. 3B and 7 show that the rotation control member 228 can be coupled or connected to a rail 260 or other portion of the ship deck 272. The rotation control member 228 member can further be connected to the second end 128 of the fuel tank 104, the second neck portion 120, or the second boss 124 of the second neck portion 120. The rotation control member 228 acts to control the rotation of the tank 104 in at least one degree of freedom, e.g., about the longitudinal axis LA.

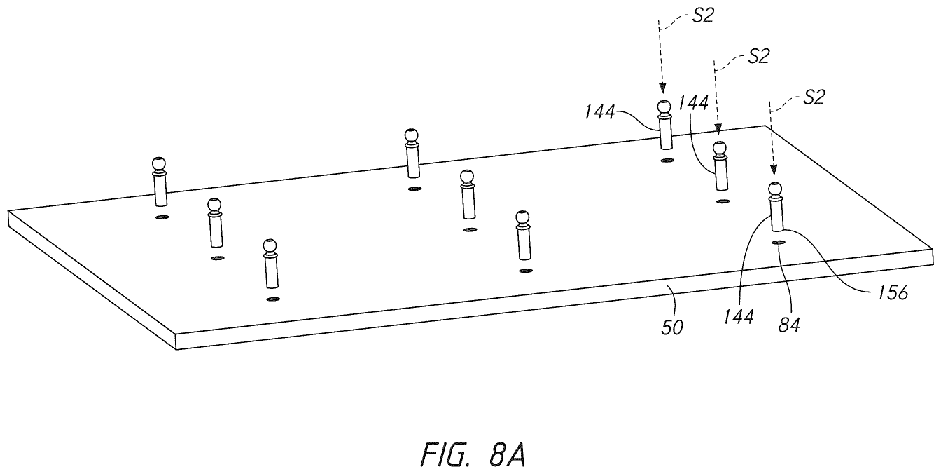

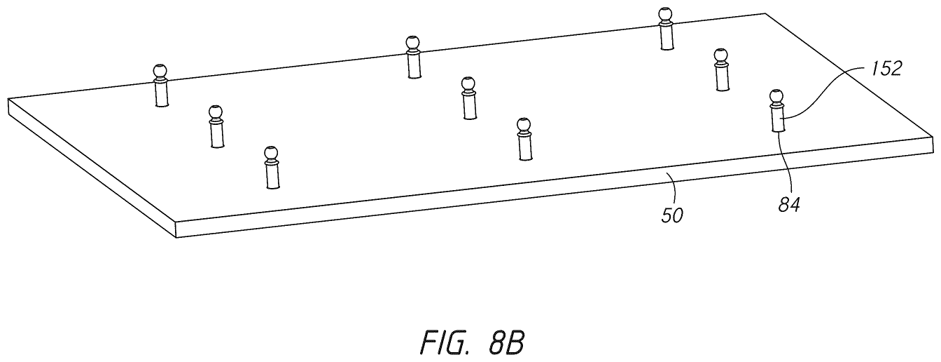

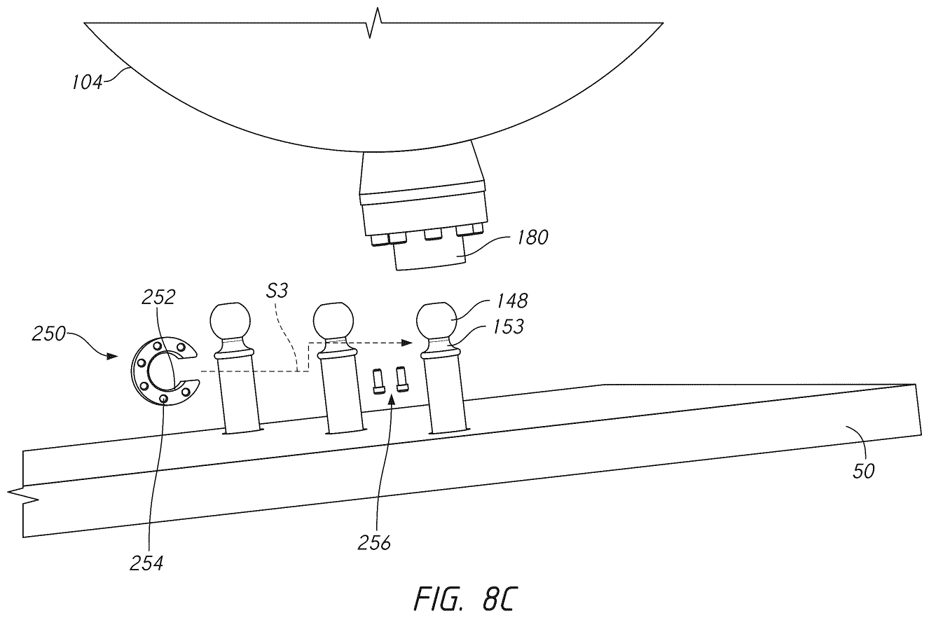

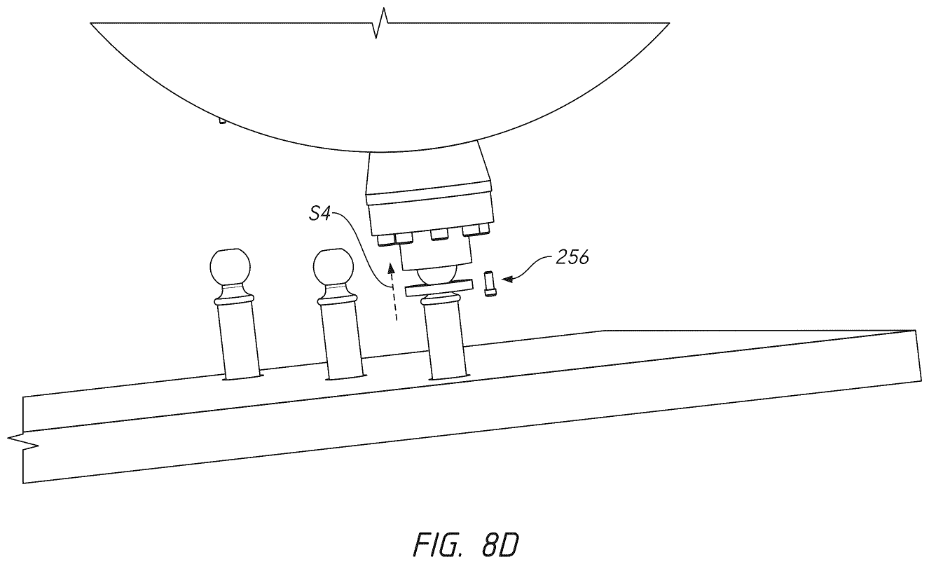

FIGS. 4 and 4A show more detail of one embodiment of the first end support assembly 142. As discussed above, the first end support assembly 142 can comprise the ground support 144 and the coupler 180. The coupler 180 of the first end support assembly 142 secures the ground support 144 to the fuel tank 104. The coupler 180 is sometimes referred to herein as a ground support coupler. The ground support 144 can comprise a ball end 148, an elongate body 152, and a free end 156 opposite the ball end 148. The elongate body 152 can extend away from the first neck portion 108 of the fuel tank 104 to the free end 156 of the ground support 144. The free end 156 can be positionable in a recess 84 that is part of or coupled to the ship 50, as discussed in connection with FIGS. 8-8D.

The first end support assembly 142 can be connected to the fuel tank 104 at the first end 116, e.g., at the first boss 112 of the first neck portion 108. The first end support assembly 142 can be coupled to the first boss 112 by advancing an array of fasteners 119 through a first array of coupler fastener apertures 190 in a body of the coupler 180 and into an array of fastener apertures 118 formed in first boss 112. The first array of fastener apertures 118 can open at an end face of the first boss 112. The first end support assembly 142 can be connected to the fuel tank 104 using any number of fasteners 119. The fastener(s) 119 can thread directly onto or into the first boss 112 of the fuel tank 104. The fasteners 119 can thread directly into threaded recesses in the first boss 112 as seen in FIG. 4A. The coupler 180 can further be connected through other methods such as welding, straps, or rivets. In some embodiments the coupler 180 can be part of the tank 104 so as to reduce components.

The ground support 144 can be circular in shape in transverse cross-section or can be another shape, such as a hexagon, triangle, octagon, rectangle, and/or square. The elongated body 152 can slide into the recess 84 in a hull of the ship 50 or can be threaded into the recess 84, as discussed below. The elongate body 152 can slide fully into the recess 84 such that the free end 156 contacts the bottom of the recess or it can be threaded into the recess 84 such that the free end floats above the bottom of the recess 84. Further there can be additional items placed in the recess, such as a block to adjust height of the tank, and the free end 156 can contact such additional items instead of the bottom of the recess.

The ball end 148 of the ground support 144 can be a spherical shape or it can be any shape that permits a pivoting type of motion of the fuel tank 104 via the first end support assembly 142. The ball end 148 can further comprise a neck portion 153 and a lip 154. The neck portion 153 can allow for engagement of a cap member 250 as discussed further below. The cap member 250 provides a two part coupler 180 that can facilitate assembly of the ball end 148 into a spherical recess in the coupler 180. The lip 154 can be a connection point between the ball end 148 and the elongate body 152. The lip 154 can further serve to limit the sway of fuel tank support system 100 or assist with the engagement of the ball end 148 with the coupler 180.

The ball end 148 is an example of a pivot structure. The ball end 148 can be pivotally engaged with coupler 180. The ball end 148 can be retained by the coupler 180 or can simply be in rotational contact with the coupler 180. In one embodiment a spherical opening 192 at a second end 196 of the coupler 180 is provided. The spherical opening 192 is another example of a pivot structure. The spherical opening 192 can extend from the second end 196 of the coupler 180 into the body thereof. In the illustrated embodiment, the ball end 148 has a spherical shape, allowing the ball end 148 to rest and rotate within the spherical opening 192 of the coupler 180. The spherical shape of the ball end 148 and of the spherical opening 192 of the coupler 180 can have a same radius. The spherical opening 192 of the coupler 180 can have a greater radius than that of the ball end 148. Other shaped openings of the coupler 180 and end portions of the ground support 144 can be provided in other embodiments, so long at the shapes allow pivoting or rotation relative to each other. The illustrated pivot structures can be inverted. For example, a convex pivot structure can be provided on a coupler 180A and a concave pivot structure can be provided on the ground support 144A. FIG. 4B shows that in some embodiments the coupler 180A can have a ball end 148A, and the ground support 144A can have an end portion with a concave spherical shape, e.g., a spherical opening 192A, allowing for the ball end 148A of the coupler 180A to sit inside a concave spherical portion of the ground support 144A. The ground support 144A can have a cap member similar to the cap member 250 to facilitate capture of the ball end 148A in the spherical opening 192A. The distance to the ball end 148A can be controlled by defining a length of an elongate body 152A extending from the coupler 180A. The coupler 180A can also include a lip 154A that is similar in structure and function to the lip 154 disposed on the ground support 144. Thus, in other arrangements the ball end 148A can be coupled to the boss 112 prior to securing the system 100 to the bottom portion 54 of the ship 50 or other maritime vessel. As discussed above, the bottom portion 54 can be a ground support (above or beneath the surface of the water) in a non-transportation application where independent movement of he ends is beneficial. In alternative embodiments the ball end 148 can include or be replaced with a pivot structure configured as a wedged point like an arrow and the spherical opening 192 can include or can be replaced with a pivot structure configured as a cone shaped recess that receives the wedged point. The cone shaped recess can have a greater internal angle than the external angle of the wedged point, e.g., can include a more obtuse angle than the wedged point so as to more easily facilitate pivoting.

In some embodiments, the sway range discussed above in connection with FIG. 1A is provided by rotation or movement of an opening (e.g., the spherical opening 192, the spherical opening 192A, or another pivot structure) over or relative to a structure received in the opening (e.g., the ball end 148 or the ball end 148A or another pivot structure) is within a range of −45 degrees to +45 degrees. In other embodiments, the range is −30 degrees to +30 degrees, −20 degrees to +20 degrees, −15 degrees to +15 degrees, or −10 degrees to +10 degrees.

The ball end 148 of the ground support 144 can be enclosed within, e.g., retained by, the coupler 180. The first end support assembly 142 can further comprise a cap member 250 that allows the coupler 180 to be disassembled to allow the ball end 148 to be installed. The cap member 250 can comprise a spherical inner periphery 252 and an array of cap fastener apertures 254 disposed outward of the spherical inner periphery. The cap member 250 can be secured to the coupler 180. The first end support assembly 142 can further comprise a plurality of fasteners 256 disposed through the array of cap fastener apertures 254 of the cap member 250 into a corresponding array of body fastener apertures 258 of a coupler body 266 of the coupler 180. The cap member 250 can act to restrict the ball end 148 from dislodging from the spherical opening 192 entirely or partially. The cap member 250 can further restrict the sway range of the system 100.

The fuel tank 104 can further comprise a plug 132 to seal the tank 104 and create an enclosed volume within the tank 104. The plug 132 can be held in place within the fuel tank 104 by threads, by a tapered interface or by other means. The coupler 180 and the plug 132 can be engaged to reduce or minimize rotation between the fuel tank 104 and the coupler 180.

FIG. 4A shows a cross section view of the first end support assembly 142 and the tank 104 to which the first end support assembly is coupled. The first boss 112 of the first neck portion 108 can be connected to the coupler 180 at a first end 188 of the coupler 180. The connection can be made with the array of fasteners 119 as discussed above. The fasteners 119 pass through first array of coupler fastener apertures 190 of the coupler 180 and secure into first array of fastener apertures 118 in the first boss 112. The first array of fastener apertures 118 of the tank 104 can be threaded, or can be able to receive a threaded insert. The first array of fastener apertures 118 can be textured or smooth. The first array of fasteners 119 can include one or more screws or can be an alternative type of connection that engages the coupler 180 to the tank 104. Further the connection between the tank 104 and the coupler 180 can employ threaded rods that are integrated into the tank 104, e.g., disposed in the first array of fastener apertures 118 of the tank 104, or they can be threaded into another end portion of the tank 104. The rods can then pass through the first array of coupler fastener apertures 190. A system can then further comprise a first array of nuts that can be used on the threaded rods to secure the coupler 180 to the tank 104.

The plug 132 can include an end portion 133, an external end 134, an internal end 135, and a non-round outer periphery 136. The internal end 135 can be inserted into the first boss 112 of the tank 104. The internal end 135 can be threaded into the first boss 112 or can engage the tank 104 in an alternative way. The external end 134 can project beyond the first boss 112. The external end 134 can include a non-round outer periphery 136. The coupler 180 can engage the external end 134 of the plug 132 when connected or partially connected to the first boss 112 of the tank 104. The coupler 180 can restrict the rotation of the plug 132 by engaging the non-round outer periphery. Similarly, the engagement of the non-round periphery of the plug 132 with a surface of the coupler 180 can reduce or eliminate relative rotation between the fuel tank 104 and the coupler 180. In some embodiments, the periphery of the external end 134 does not engage with the coupler 180, and the plug 132 is sufficiently secured to the first boss 112 such that resistance to rotation is not provided by the coupler 180.

As discussed above, the cap member 250 can be connected to the coupler 180 in a manner that facilitates receiving and retention of the ball end 148 of the ground support 144. The spherical inner periphery 252 of the cap member 250 can be configured to engage the ball end 148. The spherical inner periphery 252 can provide an extension of a spherical concavity 262 of the coupler 180. The spherical inner periphery 252 can provide the entrance into the spherical opening 192 of the coupler 180 to create a uniform inner spherical surface with which the ball end 148 can engage. Alternatively, the spherical inner periphery 252 may not match the spherical concavity 262 of the opening 192. The cap member 250 can engage the ball end 148 by completing a lower portion of the spherical opening 192, thus confining a majority of the ball end 148 to within the spherical concavity 262.

The cap member 250 can engage the ball end 148 though an alternative means that can restrict the ability of the ball end to be removed from the spherical opening 192 of the coupler 180. The cap member 250 can further comprise an array of cap fastener apertures 254 disposed about the spherical inner periphery 252. The cap member 250 can be configured to receive one or a plurality of fasteners 256 disposed through the array of cap fastener apertures 254 into the body of the coupler 180 as discussed above. The cap member 250 can be secured through the use of threaded studs. The studs can be threaded into, pressed into, captured by, or apart of the coupler 180. The studs can extend through the cap fastener apertures 254. The cap member 250 can then be secured to the coupler 180 by nuts threaded onto the studs. The cap member 250 can be secured to the coupler 180 using many other means, the fasteners and treaded studs are but two examples. The cap member 250 can be thread directly onto the coupler 180. The cap member 250 can be welded to the coupler 180. The spherical opening 192 of the coupler 180 and the spherical inner periphery 252 provide a spherical concavity 262. The spherical concavity 262 can at least partially define the sway range 100A-100B.

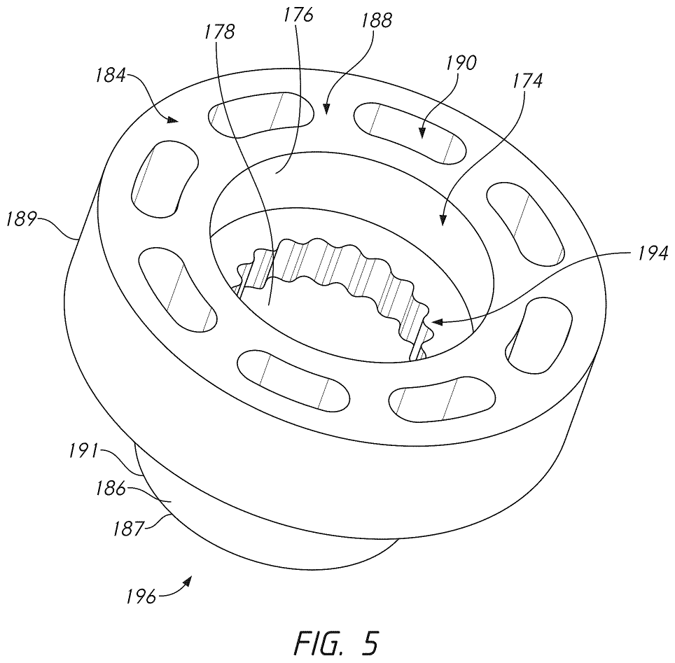

FIG. 5 shows the coupler 180 isolated from the fuel tank support system 100 and in more detail. The coupler 180 comprises a first end 188 and a second end 196. The tank boss interface 184 of the first end 188 is configured to engage with the tank 104. The tank boss interface 184 can engage with the first boss 112 of the first neck portion 108 of the tank 104. The second end 196 of the coupler 180 can engage with the ground support 144 at the spherical opening 192 as discussed above, e.g., by receiving and retaining the ball end 148 or another part of the ground support 144.

The coupler 180 can further comprise a first outer circumferential portion 189 at the first end 188 and a second outer circumferential portion 191 at the second end 196. The outer circumferential portion 189 can be configured and sized such that the first array of coupler fastener apertures 190 can engage with the first boss 112 of the first neck portion 108 of the tank 104. The circumferential portion 189 defines the outer most dimension of the coupler 180. The second outer circumferential portion 191 can be configured and sized such that the body fastener apertures 258 can be used to engage the cap member 250 with a plurality of fasteners 256 through the cap fastener apertures 254 and secured into the body fastener apertures 258. The second outer circumferential portion 191 can be substantially smaller than the outer circumferential portion 189 such that the first array of coupler apertures 190 have clearance for fasteners to be used. In further embodiments the coupler 180 can have a single circumference or more than two circumferences. Further the coupler 180 need not be circular in shape at all. The coupler 180 can have a stepped configuration with at least one step. The coupler 180 can be a rectangular, square, hexagonal, or any other shape.

In some embodiments the tank boss interface 184 can be configured to resist rotation of the fuel tank 104 relative to the coupler 180. In some embodiments the tank boss interface 184 can further comprise a tank recess 174. The tank recess 174 is configured to receive a portion of the first end 116 of the fuel tank 104 therein. For example, the tank recess 174 can have a portion of the first boss 112 disposed therein. At least a portion of the tank recess 174 can be configured, e.g., shaped, to resist rotation of the fuel tank 104 relative to the tank recess 174. In some embodiments the tank recess 174 can comprise a first recess portion 176 disposed opposite the spherical opening 192 and a second recess portion 178 disposed between the first recess portion 176 of the tank recess 174 and the spherical opening 192. The portion of the tank recess 174 shaped to resist rotation can resist the rotation of the plug 132. The portion of the tank recess 174 shaped to resist rotation of the tank 104 can be a portion of, e.g., a part of a periphery of, the second recess portion 178. The end portion 133 of the plug 132 of the fuel tank 104 can be disposed in the second recess portion 178 of the tank recess 174. Additionally, the second recess portion 178 can comprise a scalloped inner periphery 194 comprising a shape configured to engage a non-round outer periphery 136 of the end portion 133 of the plug 132 while resisting rotation therebetween. The shape of the scalloped inner periphery 194 and the non-round outer periphery 136 need not be the same shape. The scalloped inner periphery 194 can be a scalloped ratchet like shape designed to engage with a hexagonal shaped non-round outer periphery 136 of the end portion 133. The inner periphery of the second recess portion 178 and non-round outer periphery 136 can be any two shapes that allow for engagement such that rotation of the tank 104 is resisted. For example, the inner periphery of the second recess portion 178 can be an oval and the non-round outer periphery 136 of the end portion 132 can also be an oval.

The shape of the coupler fastener apertures 190 can also permit a more flexible and more secure engagement of second recess portion 178 with the plug 132, e.g., the scalloped inner periphery 194 with the non-round outer periphery 136. In the present embodiment the first array of coupler fastener apertures 190 include arc-shaped slots, allowing for rotational adjustment when the coupler 180 is secured to the tank 104. The adjustment created by an arc slot shape of the first array of coupler fastener apertures 190 can further permit the end portion 133 of the plug 132 to be placed within the second recess portion 178 in a variety of positions while facilitating connection. The first array of fasteners 119 can then be inserted through the first array of coupler fastener apertures 190 and loosely secured into the first array of fastener aperture 118 which can be threaded. The first array of fasteners 119 can tightened such that the end portion 133 of the plug 132 is restricted within the second recess portion 178, but the coupler 180 can still rotate in reference to the tank 104. The coupler 180 can then be turned such that the non-round outer periphery 136 engages the scalloped inner periphery 194. The rotation of the coupler 180 that creates the engagement between the scalloped inner periphery 194 and the non-round outer periphery 136 would be in a direction such that the engagement would resist the unthreading of the plug 132 from the tank 104. The first array of fasteners 119 can then be tightened, securing the coupler 180 to the tank 104.

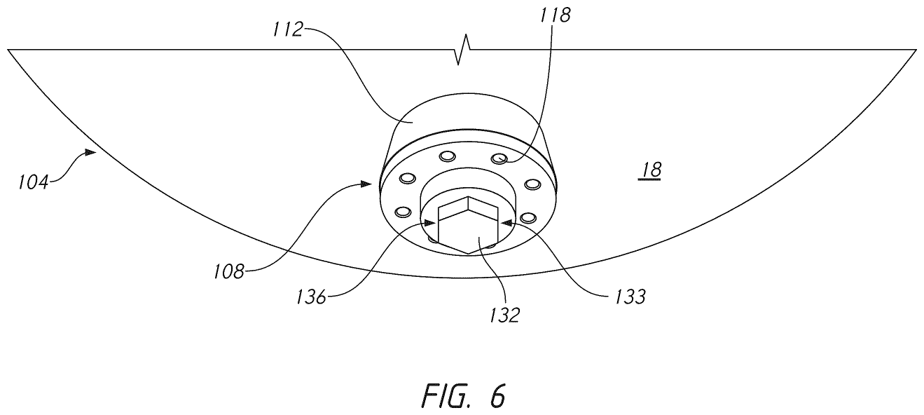

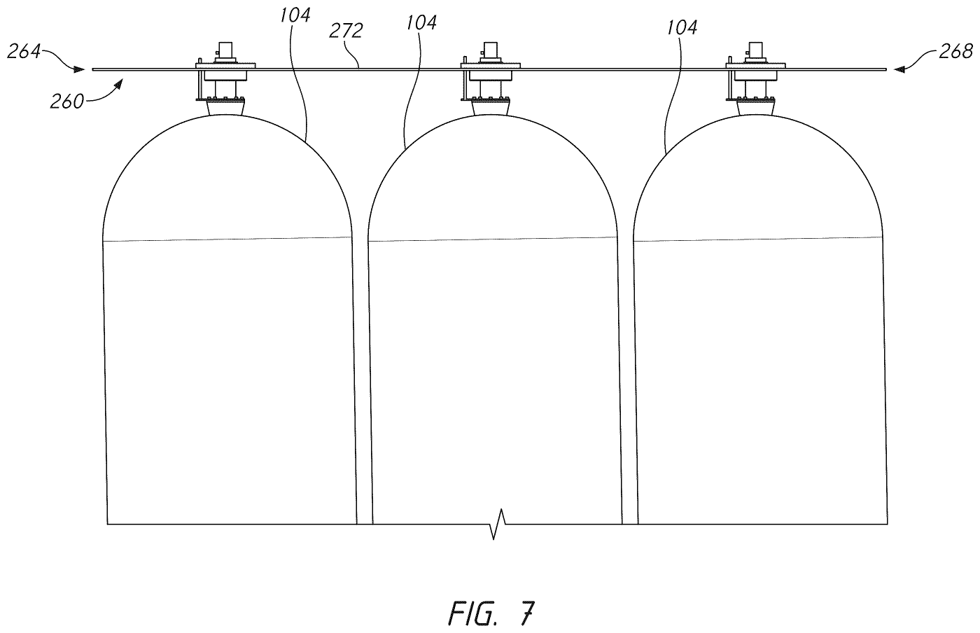

FIG. 6 shows details of the bottom portion of the tank 104 and the plug 132. The end portion 133 has a hex-shaped non-round outer periphery 136. The periphery 136 can be other non-round shapes. The non-round outer periphery 136 can be a triangle, a square, a pentagon, an octagon, or can be any shape such that the non-round periphery 136 can engage with the scalloped inner periphery 194 of the coupler 180.

FIGS. 7-7A show a side view of the second end 128 of the tanks 104. The second end 128 of the tanks 104 comprises a second neck portion 120 which comprises a second boss 124. The second end 128 of the tank 104 is connected to the second end support assembly 220. The second end support assembly 220 is also connected to a portion 260 of the ship deck 272, as discussed above. The ship deck 272 is connected to other structural portions of the ship 50, e.g., at end or peripheral portions 264, 268 of the deck. The ship deck 272 can be a solid continuous surface deck or it can have another structure. The ship deck 272 is provided to support the tanks 104 in some embodiments. The ship deck 272 can be or include a series of cables which support and locate the top of tanks 104. The ship deck 272 can be a porous surface allowing air and water to pass through to a lower compartment. The ship deck 272 can be made of the same material as the rest of the ship or of a different material to support the fuel tanks 104.

FIG. 7A shows that the second end support assembly 220 is connected to the second end 128 of the tank 104. In one configuration, the second end support assembly 220 comprises a ship deck coupler 240, a spherical member 224, a concave bearing 226, and a rotation control member 228. The spherical member 224 is slideably disposed over the outer surface 126 of the second boss 124 of the tank 104. The spherical member 224 can vertically slide up and down the outer surface 126. The outer surface 126 can be longer or shorter so as to define a sway range. The outer surface 126 can define the amount the second boss 124 can slide through the spherical member 224. The length of the second boss 124 can be sufficiently long to allow expansion of the fuel tank 104 while maintaining engagement between the outer surface 126 and the inner surface of the spherical member 224. Further the length of the second boss 124 can be determined by the length of ship, type of ship, type of hull, design of ship, design of tank, or the material of the tank. The factors can be used independently or in conjunction to calculate a sufficient length second boss 124. The spherical member can slide on the outer surface 126 and such sliding motion can be facilitated by bearings disposed between the spherical member 224 and the outer surface 126 of the second boss 124 or by direct contact, e.g., if the inner surface of the spherical member 224 comprises low friction materials, or any other type of connection that would facilitate vertical movement of the second boss 124 through the spherical member 224. The system can comprise additional components such as bearings, loops, or coatings to facilitate sliding motion.

The concave bearing 226 is disposed between the spherical member 224 and the ship deck coupler 240. The concave bearing 226 facilitates rotation or tilting between the spherical member 224 and the ship deck coupler 240. The concave bearing 226 allows the spherical member 224 to rotate/pivot in reference to the ship deck coupler 240 or vice versa. The spherical member 224 is connected to the tank 104 and the ship deck coupler 240 is connected to a portion of the ship deck, thus the tank 104 is able to rotate (or pivot) in reference to a portion of the ship deck. The spherical member 224, the concave bearing 226, or the ship deck coupler 240 can act independently or in conjunction to restrict the sway range of the system 100.

In another embodiment, the member 224 can have a concave outer surface and the concave bearing 226 can have a convex outer surface. This embodiment would facilitate similar pivot capability. The connection between the member 224, the bearing 226, and the ship deck coupler 240 can be any type that allows the ship deck coupler to rotate in reference to the spherical member, and thus the tank 104 to rotate in reference to a ship deck. In one embodiment, the ship deck coupler 240 is integrated into the ship deck to reduce the number of components to be assembled when the fuel tanks 104 are installed.

FIG. 7A further shows the tank 104 can be filled or emptied via a port P located at the second or upper end of the tank 104. The port P can be coupled with or form part of the second boss 124. The port P can further be used to adjust pressure in the tanks 104, relieve stress, provide for venting the fuel tanks 104, or for monitoring the tanks 104.

The second end support assembly 220 further comprises the rotation control member 228. The rotation control member 228 can be connected to the tank 104, e.g., to the second boss 124 or to another part of the second neck portion 120. The rotation control member 228 can be a separate component, part of or coupled with the tank 104, or part of or coupled with the ship deck coupler 240 or part of or coupled with a portion of a deck of a ship. The rotation control member 228 can comprise a plate 230 configured to couple with the tank 104. The plate 230 can be secured to the tank 104 with an array of fasteners that pass through an array of fastener apertures in the rotation control member 228. The array of fasteners can be secured into the tank 104 so as to secure the rotation control member 228 to the tank 104. The plate 230 can be an arcuate, e.g., an annular, member disposed around the second boss 124. The plate 230 can have a transverse extension 232 configured to extend laterally of a portion of the ship deck coupler 240 in one embodiment. The apertures 130 can be formed into the second neck portion 120 and can be threaded. The apertures 130 can be configured to receive inserts, such as pegs that are not threaded and can be smooth, rough, and/or tapered. The apertures 130 can include threaded studs extending from the tank 104 through apertures in the rotation control member 228. Nuts or other fastener components can then be threaded onto the threaded studs so as to secure the rotation control member 228 to the tank 104.

The rotation control member 228 can comprise a rod 234 that extends upwards toward a peripheral flange 236 of the ship deck coupler 240 or other fixed structure. The rod 234 can have a first end coupled with the plate 230 or with the transverse extension 232 of the plate 230. The rod 234 can have a free end disposed above the fixed end. The free end of the rod 234 can extend through an aperture or hole in the flange 236 of the ship deck coupler 240. The rod 234 can pass through an aperture or hole in a portion of the ship deck. The rod 234 can pass through a portion of a ship deck. The rod 234 can resist the rotation of the tank 104 in reference to the ship deck about the longitudinal axis LA of the fuel tank 104. There can be a single rod 234 or there can be multiple rods 234 used to rotationally secure the rotation control member 228 with respect to the ship deck. The rotation control member 228 is shown employing a slender rod, but in other embodiments other rigid structures can be used that resist rotation. The rotation control member 228 can engage with the ship deck or a portion thereof via a threaded rod, a locking mechanism, a weld, or a variety of other mechanisms.

In various embodiments, the rod 234 is configured to be moveable relative to the ship deck coupler 240 or to the ship deck. For example, the transverse size (e.g., diameter) of the rod 234 can be smaller than an aperture formed through the ship deck coupler 240. As the fuel tank 104 is filled, the tank can lengthen. The rotation control member 228 can be fixed with the second neck portion 120. As the tank expands the second neck portion 120 and the rotation control member 228 tend to move upward in the case of a vertically mounted tank. The ship deck or the ship deck coupler 240 generally are configured not to move upwardly. The rotation control member 228 (e.g., rod 234) can move through the aperture or hole in the ship deck coupler 240 or the ship deck. As such, the top of the second neck portion 120 and the plate 230 moves closer to and farther away from the bottom surface of the ship deck coupler 240 or the ship deck as the tank is filled and emptied. FIG. 7A can illustrate an empty or mostly empty condition. As the tank is filled, the rotation control member 228 (including the rod 234) move up toward the ship deck and ship deck coupler 240 such that the distance indicated by the double arrow A3 will become less as the fuel tank 104 is filled. In some embodiments, instead of the rod 234 moving through the aperture or hole in the ship deck coupler 240 or the ship deck, the plate 230 and/or the transverse extension 232 of the plate 230 can be coupled to the ship deck coupler 240 or the ship deck using one or more pivoting devices (e.g., hinges) and one or more arms. The one or more pivoting devices and the one or more arms can control and accommodate for the vertical movement of the tank as it is filled.

In some embodiments, the length of the rod 234 to accommodate movement of the tank 104 (or other pressure receptable) relative to the ship deck coupler 240 can be more than or between 20 mm and 200 mm. In other embodiments, the length of the rod 234 can be more than or between 10 mm and 500 mm. In some embodiments, the second boss 124 can have a length between 20 mm and 200 mm. In other embodiments, the length of the second boss 124 can be between 10 mm and 500 mm. The rod 234 can be part of an assembly including the tank 104 (or other pressure receptacle). The rod 234 can be coupled with the tank 104 (or other pressure receptacle) adjacent to a fixed end of the second boss 124. The rod 234 can extend along the second boss 124 adjacent to or beyond a free end of the second boss 124. The rod 234 can have a longitudinal axis that is parallel to a longitudinal axis of the second boss 124. The rod 234 can have a length that is greater than the length of the second boss 124 to provide rotation control over an entire range of relative motion between the second boss 124 and the spherical member 224 due to tank filling expansion and/or to swaying.

FIG. 8 shows methods for coupling a plurality of or an array of fuel tanks 104 to a first end support assembly 142, to a ship 50. The first end 116 of the tank is connected to a first end support assembly 142 prior to connecting the fuel tank 104 to the ship 50. The first end support assembly 142 comprises the ground support 144. The ground support can further comprise and elongated body 152 and a free end 156. The elongated body and free end can be inserted into the recess 84, as indicated by the arrow S1. During installation or loading, the tanks can be lowered into the ship with the first end support assembly pre-assembled. The elongated body 152 and free end 156 can then be inserted or threaded into the recess 84. Threading is but one method to adjust the height of the ground support in reference to the ground supports connection to the ship. The height of the ground support in the recess can be adjusted via spacers or other additional elements placed in one or more of the recesses 84 in the ship 50. The step illustrated by the arrow SI can be repeated for the other eight recesses 84 in the ship 50 that are illustrated in FIG. 8 providing for an array of nine fuel tank 104 to be loaded into the cargo hold of the ship 50. More than nine tanks can be supported in a larger array of recesses 84.

FIGS. 8A-D show additional methods of coupling fuel tanks 104 to the ship 50. In one method, the ground supports 144 of a plurality of the first end support assembly 142 are inserted into the recesses 84. The free end 156 of each of the elongated bodies 152 of the ground supports 144 is inserted into a corresponding recess as indicated by the arrows S2. FIG. 8B shows an array of nine ground supports 144 coupled with nine recesses 84. The ball end 148, opposite the free end 156, can then be prepared to be coupled to the coupler 180. For example, the height of the ball ends 148 can be adjusted, as indicated above. After the ground supports 144 are inserted into the recesses 84 the tanks 104 can be lowered into the cargo hold with the coupler 180 attached to the first end 116 of the tank 104 as indicated by FIG. 8C. An upper portion of the spherical opening 192 formed in the body of the coupler 180 can then be located on the ball end 148 end of the ground support 144. Arrow S3 shows that after the coupler 180 is located on the ball end 148 the cap member 250 can be slid over the neck portion 153 of the ball end 148 and secured to the coupler 180. FIG. 8D shows that the cap member 250 can be advanced as indicated by the arrow S4 onto the lower end of the body of the coupler 180. Thereafter, the cap member 250 can be secured by a plurality of fasteners 256 to the lower surface of the body of the coupler 180. The plurality of fasteners 256 can pass through a cap fastener apertures 254 of the cap member 250 and into the body fastener apertures 258 of the coupler 180. The body fastener apertures 258 can be threaded or have threaded inserts.

It should be noted that there can exist embodiments of this system where multiple tanks are suspended in parallel. The multiple tanks can share a first end support assembly 142 and/or a second end support assembly 220. Thus the tanks 104 would sway together.

FIG. 7A and other figures show that this disclosure also includes inventive tank arrangements. The fuel tank 104 has been described in detail above. The fuel tank 104 also includes a neck portion, e.g., a second neck portion 120, that includes a second boss 124. The outer surface 126 of the second boss 124 includes a first surface portion 127A and a second surface portion 127B. The first surface portion 127A comprises a first length of the second boss 124 that is configured to be supported by a ship deck coupler over a first range of positions between an empty tank condition and a full tank condition. That is, the fuel tank 104 can expand from the configuration seen in FIG. 7A to be longer. While the ship deck coupler 240 remains stationary, the second boss 124 slides within the spherical member 224 along a distance that can correspond to the length of the first surface portion 127A. After the fuel tank 104 is full, the fuel tank 104 can move upwardly by a second length of the second boss 124 that corresponds to the second surface portion 127B. The second surface portion 127B provides some range of motion to allow the fuel tank 104 in a full condition to move further upwardly over a second range of positions between a full tank tilted orientation and a full tank vertical orientation. The full tank tilted orientation resulting from swaying of the fuel tank away from the full tank vertical orientation relative to a support structure with which the tank is coupled. This can allow the tank to be filled in a tilted orientation and to still be accommodated in a vertical orientation.

While filling and emptying of the cylinders is described, the systems described herein may also be used to store and transport fuel tanks, whereby the fuel tanks are loaded onto the ship 50 and removed from the ship 50, instead of being filled and emptied while remaining on the ship 50.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A pressure receptacle support system, comprising:
a pressure receptacle comprising a central portion disposed along a longitudinal axis, a first end and a second end opposite the first end, the first and second ends being disposed along the longitudinal axis;
a first end support assembly fastened to the first end, the first end support assembly comprising:
a ground support; and
a coupler having a receptacle interface at a first end and a rotation interface at or extending from a second end opposite the first end, the receptacle interface being fastened to the first end of the pressure receptacle;
wherein a sway range for the pressure receptacle is provided by rotation of the rotation interface of the coupler relative to the ground support and relative motion of the second end of the pressure receptacle relative to a portion of a deck of a maritime vessel.

13. The pressure receptacle support system of claim 12 wherein the rotation interface comprises a spherical opening disposed within the coupler.

14. The pressure receptacle support system of claim 12 wherein the ground support further comprises a ball end, an elongate body and a free end opposite the ball end, the elongate body insertable into a recess coupled with a bottom portion of a maritime vessel.

15. The pressure receptacle support system of claim 12, wherein the pressure receptacle further comprises a first neck portion comprising a first boss at a first end and wherein the receptacle interface is coupled with the first neck portion.

16. The pressure receptacle support system of claim 15, wherein the pressure receptacle further comprises a second neck portion comprising a second boss at the second end, the pressure receptacle support system further comprising:
a second end support assembly coupled with the second neck portion, the second end support assembly comprising:
a maritime vessel deck coupler configured to be secured to a portion of a deck of a maritime vessel;
a rotational member coupled with an outer surface of the second boss; and
a rotational connection disposed between the rotational member and the maritime vessel deck coupler.

17. The pressure receptacle support system of claim 16, further comprising a rotation control member secured to the second end of the pressure receptacle, the rotation control member slideably but non-rotatably disposed relative to the maritime vessel deck coupler providing mechanical coupling of the pressure receptacle to a portion of an upper deck of a maritime vessel.

18. The pressure receptacle support system of claim 12, wherein the receptacle interface is configured to resist relative rotation between the pressure receptacle and the coupler of the first end support assembly.

19. The pressure receptacle support system of claim 12, wherein the receptacle interface comprises a recess having a portion of the first boss disposed therein, at least a portion of the recess shaped to resist rotation of the pressure receptacle relative to the recess.

20. The pressure receptacle support system of claim 19, wherein the recess comprises a first portion disposed opposite the spherical opening and a second portion disposed between the first portion and the spherical opening, a plug of the pressure receptacle having an end portion disposed in the second portion of the recess and wherein the second portion comprises a non-round inner periphery engaged with a non-round outer periphery of the end portion of the plug.

21. (canceled)

22. The pressure receptacle support system of claim 16, wherein the coupler comprises an outer circumferential portion having an array of coupler fastener apertures disposed therethrough, a plurality of fasteners being secured in the coupler fastener apertures and in an array of boss fastener apertures formed in an end face of the first boss, the spherical opening at least partially formed in a projection of the coupler extending between the outer circumferential portion and a free end of the coupler.

23. The pressure receptacle support system of claim 16, further comprising a cap member comprising a spherical inner periphery and an array of cap fastener apertures disposed about the spherical inner periphery, a plurality of fasteners disposed through fastener apertures of the array of cap fastener apertures into apertures of a corresponding array of body fastener apertures of a body of the coupler, the spherical opening of the coupler and the spherical inner periphery of the cap member providing a spherical concavity at least partially defining the sway range.

24. The pressure receptacle support system of claim 14 wherein the elongate body of the ground support is configured to adjustably mate with the recess of the maritime vessel by adjusting an elevation of the ball end relative to one or both of a surface from which the recess extends and the portion of the deck of the maritime vessel.

25. (canceled)

26. The pressure receptacle support system of claim 16, wherein the rotational member is moveable along the outer surface of the second boss by a first amount during the filling of the pressure receptacle and by a second amount during swaying motion of the pressure receptacle within the sway range and wherein the rotational member is moveable over the outer surface of the boss between 0 mm and 10 mm due to expansion during filling and due to swaying.

27. (canceled)

28. A pressure receptacle support system providing sway control for a pressure receptacle, comprising:
a first end support assembly configured to couple with a first neck portion of a vertically oriented pressure receptacle, the first end support assembly comprising:
a ground support comprising a first pivot structure, an elongate body and a free end opposite the first pivot structure, the elongate body configured to extend away from the first neck portion to the free end;
a coupler having a receptacle boss interface configured to couple with a first boss at a first end and a second pivot structure at or extending from a second end opposite the first end; and
a second end support assembly configured to couple with a second neck portion of a vertically oriented pressure receptacle, the second end support assembly comprising:
an upper coupler configured to be secured to an upper support structure; and
a spherical member configured to be coupled with an outer surface of a second boss of a pressure receptacle, the spherical member being mounted within and pivotable relative to the upper support structure;
wherein a range of angulation is provided by rotation of the spherical opening of the coupler over the ball end of the ground support and by sliding of the spherical member along the second boss.

29. The pressure receptacle support system of claim 28, a rotation control member configured to be secured to a second boss of a pressure receptacle to restrict rotation while permitting movement of the pressure receptacle relative to the upper support structure.

30. The pressure receptacle support system of claim 28, wherein the receptacle boss interface is configured to resist relative rotation between a pressure receptacle and the coupler of the first end support assembly.

31. The pressure receptacle support system of claim 30, wherein the receptacle boss interface comprises a recess configured to receive a portion of a boss of a pressure receptacle, the recess shaped to resist rotation of a pressure receptacle relative to the recess.

32. The pressure receptacle support system of claim 28, wherein a recess comprises a first portion disposed opposite the spherical opening and a second portion disposed between the first portion and the spherical opening, the second portion configured to receive an end portion of a plug of the pressure receptacle being.

33. The pressure receptacle support system of claim 32, wherein the second portion comprises a scalloped inner periphery configured to engage a non-round outer periphery of the plug.

34. The pressure receptacle support system of claim 33, wherein the scalloped inner periphery of the recess and the non-round outer periphery of the plug facilitate a plurality of connection orientation spaced apart by 10 degrees.

35. The pressure receptacle support system of claim 28, wherein the coupler comprises an outer circumferential portion having an array of coupler fastener apertures disposed therethrough, the fastener apertures configured to be secured to an array of receptacle fastener apertures formed in a pressure receptacle, the spherical opening at least partially formed in a projection of the coupler extending between the outer circumferential portion and a free end of the coupler.

36. The pressure receptacle support system of claim 28, further comprising a cap member comprising a spherical inner periphery and an array of cap fastener apertures disposed about the spherical inner periphery, the array of cap fastener apertures configured to receive a plurality of fasteners disposed therethrough into a corresponding array of body fastener apertures of a body of the coupler, the spherical opening of the coupler and the spherical inner periphery providing spherical concavity at least partially defining a range of sway motion.

37. (canceled)

38. (canceled)

39. The pressure receptacle support system of claim 28, wherein the first pivot structure comprises a convex surface at an end of the ground support and wherein the convex surface comprises a ball end of the ground support.

40. (canceled)

41. The pressure receptacle support system of claim 28, wherein the second pivot structure comprises a concave surface—at or extending from the second end opposite the first end and wherein the concave surface comprises a spherical opening.

42. (canceled)

43. A pressure receptacle comprising:
a central portion disposed along a longitudinal axis;
a first neck portion comprising a first boss at a first end of the central portion, the first boss comprising a first array of fastener apertures;
a second neck portion comprising a second boss at a second end of the central portion opposite the first end, the second boss comprising a second array of fastener apertures; and
a plug sealing one end of a volume disposed within the central portion;
wherein the second boss comprises a first length configured to be supported by a maritime vessel deck coupler over a first range of positions between an empty condition and a full condition and a second length configured to be supported by a maritime vessel deck coupler over a second range of positions between a full tilted orientation and a full vertical orientation, the full tilted orientation resulting from swaying of the pressure receptacle away from the full vertical orientation relative to a support structure with which the pressure receptacle is coupled.
